(19) United States
(12) Patent Application Publication
(10) Pub. No.: US 2022/0142312 A1
(43) Pub. Date: May 12, 2022

(54) CANE WITH MOTION INITIATED ILLUMINATOR

(71) Applicant: ProtoStar, Inc., a Delaware Corporation, San Diego, CA (US)

(72) Inventors: Craig Timothy Shugert, Rancho Santa Fe, CA (US); Peter James Fellingham, San Diego, CA (US)

(73) Assignee: ProtoStar, Inc., a Delaware Corporation, San Diego, CA (US)

(21) Appl. No.: 17/151,587

(22) Filed: Jan. 18, 2021

Related U.S. Application Data
(63) Continuation-in-part of application No. 17/092,098, filed on Nov. 6, 2020.

(51) Int. Cl. A45B 3/04; A45B 9/02; A45B 9/04; F21V 23/04; F21V 23/00; F21S 9/02; F21V 23/06; F21V 21/08

(52) U.S. Cl. CPC A45B 3/04; A45B 9/02; A45B 9/04; F21V 23/0492; F21Y 2115/10; F21S 9/02; F21V 23/06; F21V 21/0808; F21V 23/003

(57) ABSTRACT

The device disclosed herein is a walking cane comprised of an elongate shaft having a proximal end and a distal end. The proximal end includes a handle member having a grip surface and forward-facing front face. The front face comprises a steel surface for attaching an LED illuminator having a magnet attached to the illuminator. A magnet formed into or attached to the back of the LED illuminator attaches to the steel surface of the front face of the handle to hold the LED illuminator in place. The illuminator has an on-board battery to provide power to the light. The LED illuminator additionally includes a motion sensor and an ambient light sensor such that the LED illuminator when attached to the walking cane will activate upon the sensors detecting both motion of the waking cane and a low light condition.

### CROSS-REFERENCE TO RELATED APPLICATIONS

This application is a continuation-in-part of and claims priority to co-pending U.S. application Ser. No. 17/092,098, filed Nov. 6, 2020, the entire contents of which are hereby fully incorporated herein by reference for all purposes.

### STATEMENT RE: FEDERALLY SPONSORED RESEARCH/DEVELOPMENT

Not Applicable

### BACKGROUND

### 1. Technical Field

This disclosure relates generally to a walking cane to assist in mobility, and more particularly to a walking cane having a light activated by motion and low light conditions.

### 2. Description of Related Art

Assistive mobility devices, including walking canes, are well known as a useful means to assist mobility impaired individuals. As life expectancy increases over the decades the mobility-impaired population increases much faster than the general population, creating greater demand for walking aids. Also, in many instances, older individuals may have reduced visual acuity, including reduced night vision capacity. Also, older individuals in low light or dark areas attempting to walk with or without a walking aid, can become disoriented, walk into objects or lose balance as a result of poor low-light vision. In each of these instances, the chances are increased that an individual may be involved in a fall or other event resulting in injury. As such, there is a growing demand for improved walking aid devices such as walking canes and also for devices that provide improved pathway lighting for individuals in dark or poorly lighted areas in their homes or elsewhere.

Walking canes having lights are known. For example, U.S. Pat. No. 10,258,119 issued Apr. 16, 2019 to Cox entitled Cane With LED Lights discloses a walking cane with strands of LED lights coiled around a cane, wherein the lights are activated by a switch, the substance of which is incorporated herein by reference in its entirety. Likewise, walking assistive devices having lights are disclosed in: U.S. Pat. No. 9,877,553 issued Jan. 30, 2018 to Zimmerman entitled Auto Illuminating Walking assistant; and U.S. Pat. No. 10,186,129 issued Jan. 22, 2019 to Hood entitled Locomotion Safety and Health Assistant, both of which are incorporated herein by reference in their entirety.

All patents and publications referenced herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### BRIEF SUMMARY

The inventive subject matter described herein demonstrates a walking cane having an onboard lighting system that automatically activates upon movement of the walking cane when an on-board sensor detects low light conditions.

The disclosed embodiments of the walking cane may assist persons that use walking aid devices and the device uses an on-board night light that activates automatically when the cane is moved provided an on-board sensor determines a low light condition. The embodiments of the disclosed cane will aid seniors or other mobility impaired individuals who need to move about at night with a cane. The on-board light is attached to the ergonomically formed cane head having a front face directed forward to light a walking path. The on-board light such as an LED light or other illumination source is powered by an on-board battery and attaches to the front face of the cane where the front face may have a steel surface, and the light is releasably connected to the face via a magnet, an adhesive pad or other attachment mechanism such as a hook and loop type attachment.

The cane also has an on-board ambient light sensor to determine the existence of low light conditions in the immediate environment. In addition, the cane has a touch sensor or movement sensor. As such, the light automatically activates upon both sensor conditions being met. For example, if the cane is touched or moved and the environment is sensed as a low light condition, the illumination source is activated.

The disclosed device demonstrates a walking cane having an elongate support shaft with a proximal end with a handle attached for the user to grip and a distal end having a rubber foot. The handle member is ergonomically shaped and includes a front face projecting forward and at a downward angle. The front face includes a steel surface to engage a magnet attached to the rear of an LED light illumination source. Due to the magnet attached to the LED light and the steel surface of the front face of the handle, the LED light is removably attachable to the front face of the handle. Removal and attachment of the LED light to the cane is advantageous as the LED light may be charged via a power port such as a USB or USB-C port, and the light can be removed to recharge an internal rechargeable battery. Also, the LED light may be easily removed and replaced. In one embodiment, the steel surface includes raised edges to prevent slippage of the LED light from becoming detached from the cane handle during normal usage. In other embodiments, the LED light may be attached to the cane handle via adhesive or hook and loop fasteners.

The LED light includes both a motion sensor and ambient light sensor. The LED light is activated upon the motion sensor detecting movement of the cane or upon detecting motion in proximity to the cane and upon the ambient light sensor detecting low light conditions. For example, in normal lighting conditions, the LED light would remain inactivated when there is movement of the cane or there is motion in proximity of the cane. Also, in low light conditions, when the ambient light sensor detects low light conditions, the LED light would remain inactivated without movement of the cane or the detection of motion in proximity of the cane. The LED light is activated upon both the motion sensor detecting movement of the cane or motion in proximity of the cane and ambient light sensor detecting low light conditions. In this way the LED light remains inactive to conserve battery and to avoid being lighted in a dark room when the cane is not in use, or when there is ample ambient light. Upon cessation of motion of the cane or cessation of motion in proximity of the cane, or light levels reaching sufficiently lighted lighting conditions, the light deactivates. For example in operation, a user can leave the cane near their bedside and upon waking to use the bathroom, upon grasping and moving the cane or upon the sensor detecting movement in proximity of the cane, if the room is dark, the LED light would activate, directing light toward a walking surface, or in a direction as directed by the user to aid the user to navigate a dark room. Upon returning to bed, the user can park the cane near the bedside again, and upon cessation of movement of the cane or movement of the user or other movement in proximity to the cane, the LED light would deactivate so as to not keep the user awake by unwanted light.

Further benefits and advantages of the disclosed device will become apparent after careful reading of the detailed description with appropriate reference to the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a view of the disclosed walking cane having an on-board light;

FIG. 2 is an exploded view of the walking cane head showing the parts of the light and attachment to the cane head;

FIG. 3 is a side view of the head that serves as a handle of the disclosed walking cane;

FIG. 4 is a cross-sectional view of the cane head of the disclosed walking cane;

FIG. 5 is an exploded view of a cane head of a further embodiment of the disclosed walking cane using an adhesive attachment;

FIG. 6 is a cross-sectional view of the cane head of the walking cane shown in FIG. 5;

FIG. 7 is an exploded cross section view of a cane head of a further embodiment of the disclosed waking cane having a light insert;

FIG. 8 is an enlarged cross-sectional view of the cane head of the embodiment of the walking cane shown in FIG. 7;

FIG. 9 is an exploded view of a further embodiment of the disclosed walking cane wherein a shallow cup is attached to the cane head to aid in keeping the light attached to the cane head;

FIG. 10 is an exploded cross-sectional view of the further embodiment of the disclosed walking cane of FIG. 9;

FIG. 11 is a cross-sectional view of the items of FIG. 10 shown assembled;

FIG. 12 is a diagram of the electrical components of the illumination source; and

FIG. 13 is a flow chart describing the method of forming a lighted walking cane.

### DETAILED DESCRIPTION

The detailed description set forth below in connection with the appended drawings is intended as a description of certain embodiments of a walking cane having a light with sensors and/or related method and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

The background, summary and the description herein includes information that may be useful in understanding the present disclosure. It is not an admission that any of the information provided herein is prior art or relevant to the presently claimed inventive subject matter, or that any publication specifically or implicitly referenced is prior art.

In some embodiments, the numbers expressing dimensions, quantities, quantiles of ingredients, properties of materials, and so forth, used to describe and claim certain embodiments of the disclosure are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the disclosure are approximations, the numerical values set forth in the specific examples are reported as precisely as practicable. The numerical values presented in some embodiments of the disclose may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the disclosure and does not pose a limitation on the scope of the claimed inventive subject matter. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed. Various objects, features, aspects and advantages of the inventive subject matter will become more apparent from the following detailed description of preferred embodiments, along with the accompanying drawing figures in which like numerals represent like components.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

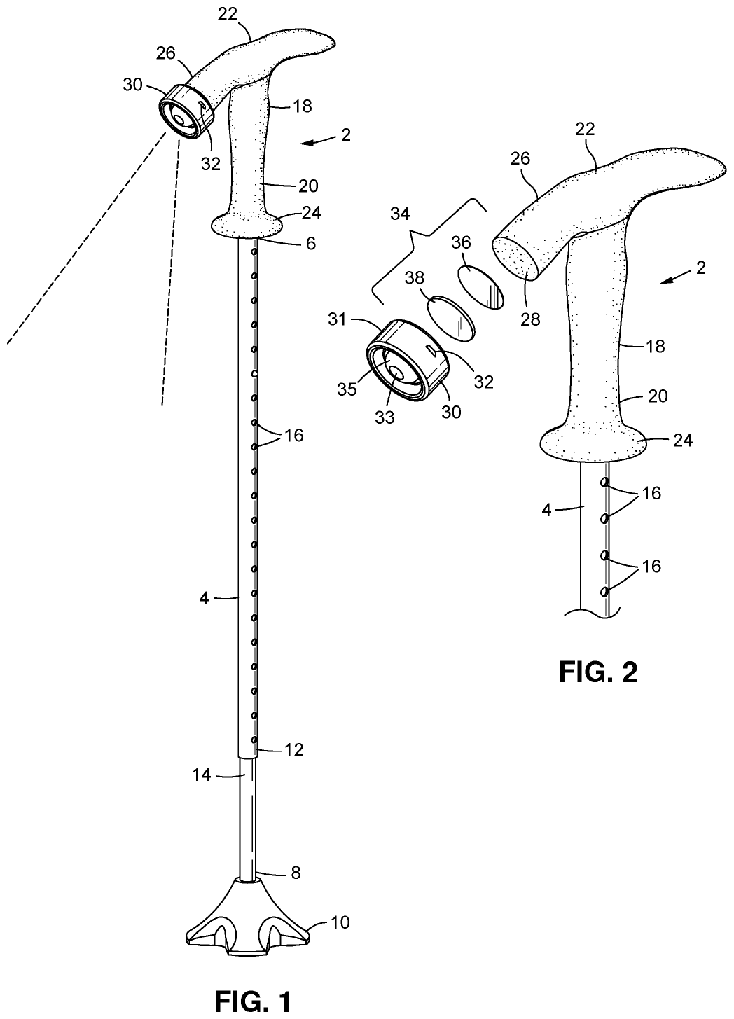

Referring particularly to FIG. 1 there is shown the disclosed cane device 2. The cane 2 comprises an elongate shaft 4 having a proximal end 6 and a distal end 8. The shaft 4 is formed of steel or aluminum however, the disclosure contemplates the shaft 4 may be formed of any rigid sturdy material. The distal end 8 attaches to a rubber foot 10. The rubber foot 10 shown includes four prongs for increased stability and provides sufficient stability so that the cane 2 can stand upright without other assistance. Also, the foot 10 protects the shaft 4 from contacting the floor directly and aids in traction and stability for the user. It is understood and contemplated by the disclosure that any operable foot may be functional and used in placed of the foot 10 such as three prong foot or other rubber end that protects the shaft 4 from contacting the ground directly and provides additional gripping to the floor to be resistant to slippage. The shaft may comprise two sections, an outer shaft 12 and an inner shaft 14 having a lesser diameter to be received within the outer shaft to cause a telescoping action so that the cane 2 length may be adjusted and secured into place via openings 16 and a detent mechanism (not shown) attached to the inner shaft 14 to engage one or more of the openings 16 of the outer shaft that provides a secure stop to hold the inner shaft 14 and outer shaft 12 in place without slippage. The detent mechanism (not shown) can be pushed inwardly to disengage one or more of the openings 16, so that the shafts 14 and 12 may be telescoped to allow the detent mechanism to re-engage with another opening 16 via a biasing member (not shown) to push the detent mechanism into an opening 16.

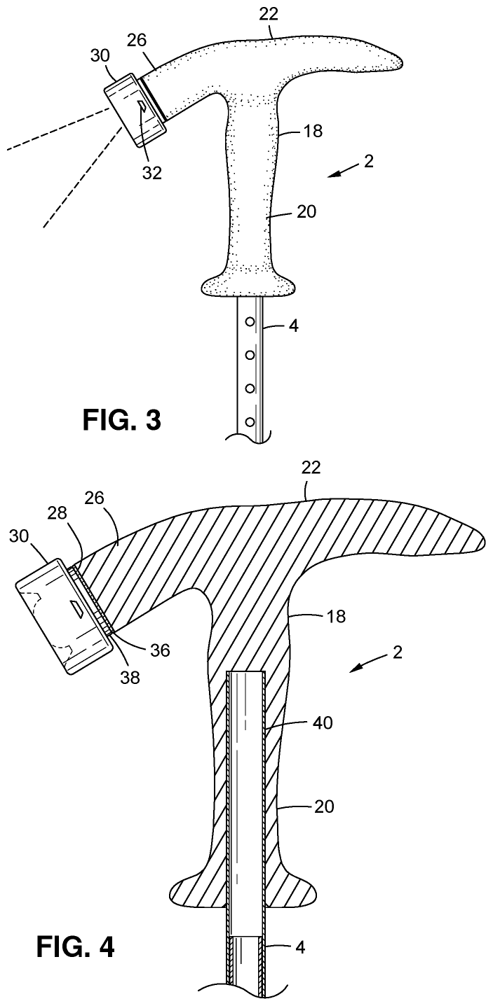

A cane head 18 is attached to the shaft 4. The cane head 18 is formed from strong rigid plastic or composite plastic, although it is contemplated by this disclosure the cane head may be formed of any suitable strong rigid material such as PVC, wood or metal. The cane head 18 comprises a vertical grip 20 and a horizonal grip 22. Although the terms horizonal and vertical are used to describe grips 20 and 22, the grips may not be completely horizonal or vertical as can be seen and disclosed in the drawings. A user may grasp the vertical grip 20 to use the cane 2 more like a walking stick, or the user may grasp the horizonal grip 22 to place more weight on the cane 2 to use the cane 2 more as a traditionally fashioned cane. The vertical grip 20 may include a lip 24 at the base of the cane head 18 to prevent slippage of a hand from the grip 20 during use. The cane head 18 horizontal grip 22 includes a forward protrusion 26 angled downwardly. The protrusion 26 includes a circular forward face 28 (shown in FIG. 2) that provides a connection surface for a detachable LED light 30.

The LED light 30 or illumination source light includes both a motion sensor and ambient light sensor. The LED light 30 is activated upon the motion sensor detecting movement of the cane or upon detection of movement in proximity to the cane and upon the ambient light sensor detecting low light conditions. For example, in normal lighting conditions, the LED light 30 remains inactivated when there is movement of the cane or the motion sensor detecting movement in proximity to the cane. Also, in low light conditions, when the ambient light sensor detects low light conditions, the LED light would remain inactivated without movement of the cane or without movement in proximity to the cane. The LED light is activated upon both the motion and ambient light sensors detecting movement and low light conditions respectively. In this way the LED light 30 remains inactive to conserve battery when the cane is not in use and there is no movement in proximity of the cane, or when there is ample ambient light. Chart 1 shown below shows the different states of the LED light 30 in correspondence with the two sensors.

CHART 1
LED Activation

| Motion Sensor | Light Sensor | Light |
|---|---|---|
| Does not detect | Detects sufficient | OFF |
| motion | light | |
| Detects motion | Detects sufficient | OFF |
| | light | |
| Does not detect | Detects low light | OFF |
| motion | condition | |
| Detects Motion | Detects low light | ON |
| | condition | |

An advantage of the use of an automatically activated light is important to avoid having to find and activate a switch in the dark, for example. Upon cessation of motion, or light levels reaching normal sufficient light lighting conditions the light 30 deactivates. For example, in operation, at night a user can leave the cane 2 near their bedside and upon rising from bed to use the restroom, upon the motion sensor detecting movement of the user or the user grasping and moving the cane 2, if the room is dark, the LED light 30 would activate directing light toward the walking surface or in a direction as directed by the user to aid the user to navigate a dark room. Upon returning to bed, the user can park the cane 2 near the bedside again, and upon cessation of movement of either the cane or motion in proximity of the cane, the LED light 30 would deactivate in low light conditions so as to not keep the user awake with unwanted light. The timing of the deactivation of light after cessation of movement is approximately thirty (30) seconds, however, any suitable time delay may be used, or the immediate deactivation of the light upon non-movement is contemplated by the disclosure.

The LED light 30 or illumination source may comprise the rechargeable Portable LED Night Light model No. BT-PK-25 manufactured by Shenzhen Bestto Technology, Co. Ltd. of Shiyan Town, China. The LED light 30 may be a circular shape formed by a circular housing 31 having dimensions of approximately 52 mm in Diameter. An LED 33 is positioned in the center of the housing to direct light outwardly through a diffuser 35 positioned around the LED 33. The DC input voltage of the LED light 30 is provided by an internal rechargeable battery is 5V DC. The illumination source LED light 30 may be rechargeable via a power port 32 such as USB or USB-C port. Although the LED light 30 is shown using a power port 32 for charging a battery (not shown) it is contemplated that the internal battery could be charged by induction coil. Also, a replaceable battery such as coin cell battery may be used. The motion sensor of the LED light is an infrared induction light that senses movement of the cane 2 or movement in proximity to the cane via infrared signal. It is also contemplated that an accelerometer or other like sensors may be used for detecting motion. The ambient light sensor may be a light dependent resistor (LDR) or photo resistor or any other applicable sensor that is capable of sending a signal to indicate low light conditions or when the ambient light intensity reaches a threshold level. The LED light 30 may also have an onboard controller (not shown) that receives signals from both the motion sensor and ambient light sensor to determine whether to activate the LED of the light 30 and to send a signal to activate and provide power from the battery (not shown). The disclosure contemplates use of white LED light illuminated from the light 30, however, any color LED light may be used.

Referring particularly to FIG. 2 there is shown an exploded view of the attachment device 34 by which the LED light 30 is attached to the face 28 of the cane head 18. A circular shaped flat steel plate 36 is attached to the face 28 of the cane head 18. The plate 36 is attached by adhesive or other bonding. In addition, the steel plate 36 could be installed just below the surface of the face 28 to provide an attraction surface for coupling with a magnet. The attachment device 34 additionally includes a strong disc shaped magnet 38 that attaches to a housing 31 of the LED light 30. The magnet is centered on the back of the LED light 30 housing so that it can be centered on the face 28 by coupling the magnet 38 to the steel plate 36 to hold the LED light 30 in place on the cane head 18. The magnet 38 shown exploded from the housing 31, however it is contemplated that the magnet 38 may be integral to the housing 31, being directly attached to the rear of the housing 31 or within housing 31 at the rear of the LED light 30.

Referring to FIG. 3 there is shown a side view of the cane head 18 attached to the shaft 4 wherein the LED light 30 is attached to the face 28 (not shown). As is shown in FIG. 3, the protrusion 26 from the horizonal grip 22 extends downwardly such that the attached light 30 directs its illumination downwardly toward the floor or ground surface when the cane 2 is positioned vertically.

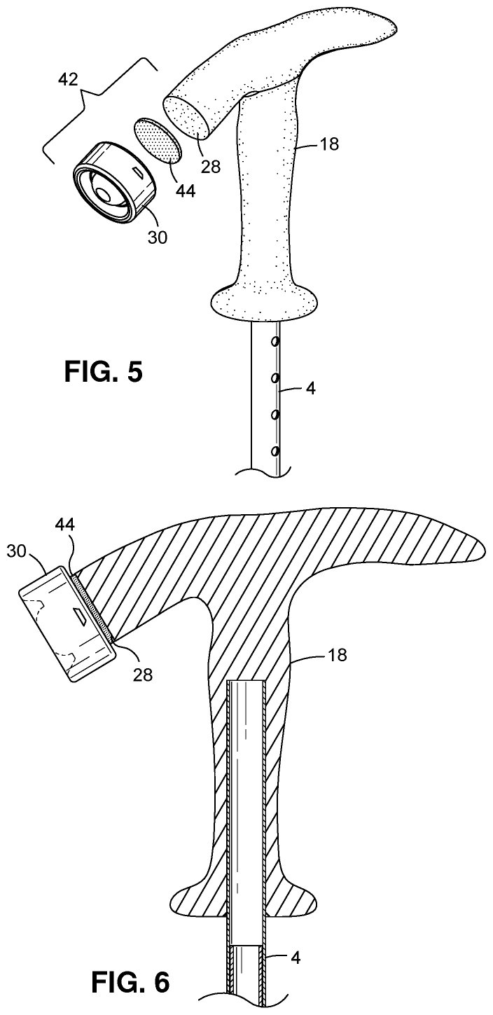

Referring to FIG. 4, there is shown a cross sectional view of the cane head 18 in FIG. 3. The cross section shows the solid plastic or composite material of the head 18, except that a cavity 40 is formed within the cane head 18 to receive the top of shaft 4 for a secure fit and attachment. The cross section shows the placement of the steel plate 36 on the face 28, with the magnet 38 coupled to the steel plate 36 on one side, and attached to the LED light 30 on the other side.

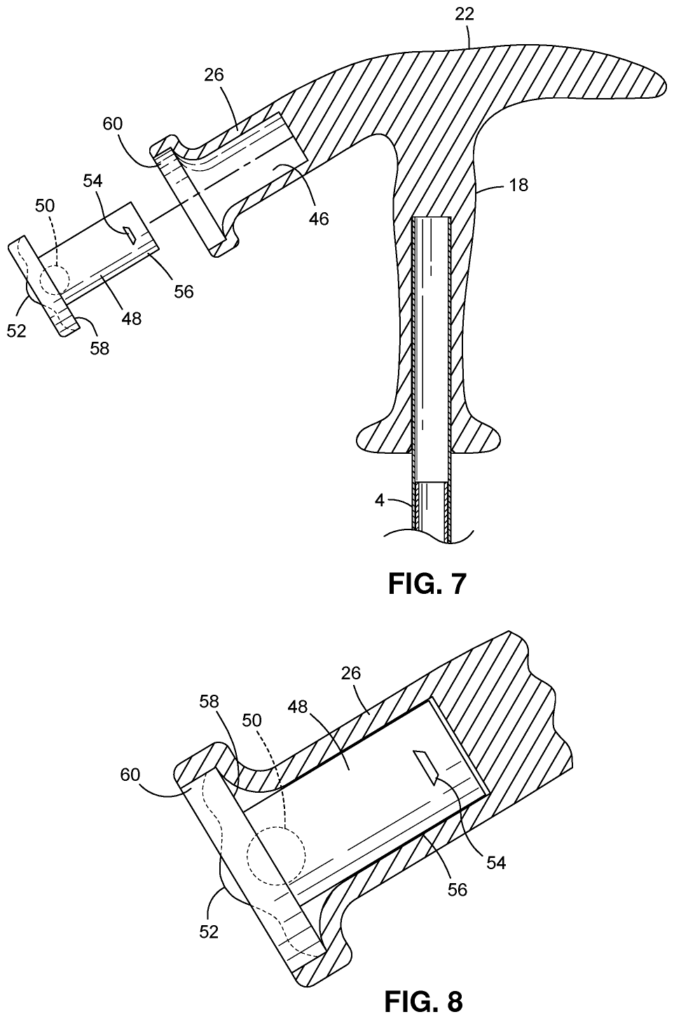

Referring to FIG. 5 there is shown an alternate method or apparatus for attaching the LED Light 30 to the face 28 of the cane head 18. The alternate device 42 include a two-sided adhesive disc 44 that adheres to the back of the LED light 30 housing and to the circular face 28 of the cane head 18. FIG. 6 shows a cross section of FIG. 5, showing the LED light 30 coupled to the face 28 with via the two-sided adhesive disc 44.

Referring to FIGS. 7 and 8 there is shown a further embodiment of the cane 2 and the cane head 18 is attached to the shaft 4 by shown in cross section. In the further embodiment shown in FIGS. 7 and 8 the protrusion 26 is formed differently, with an interior cavity 46 shaped to receive an alternately shaped LED light housing 48. The light housing 48 includes each of the components of the LED light 30, including but not limited to an LED 50, LED diffuser 52, a USB or USB-C port 54 and on board battery (not shown), and motion and ambient light sensors, in electrical communication with a controller for activating and deactivating the LED 50. The operation of the LED 50 in the LED housing 48 operates identically to the LED 30 described with regard to previous embodiments. FIG. 7 shows the LED housing 48 exploded away from the cane head 18 and FIG. 7 shows the LED housing 48 coupled to the cane head 18 by being inserted into the cavity 46. The housing 48 incudes a cylindrical base 56 which is sized to be frictionally received within the cavity 46. The housing 48 additionally includes a circular lip 58 formed at the top of the cylindrical base 56. The cavity 46 is narrower at the interior, and flairs outwardly to form a circular recess 60 adapted and sized to receive end engage with the circular lip 58. The housing 48 nests within the cavity 46 and recess 60 to be enveloped within the protrusion 26 of the cane head 18. The nested housing 48 prevents the housing 48 from being pushed sideways or decentered during us since the sides of the housing 48 are unavailable for contact.

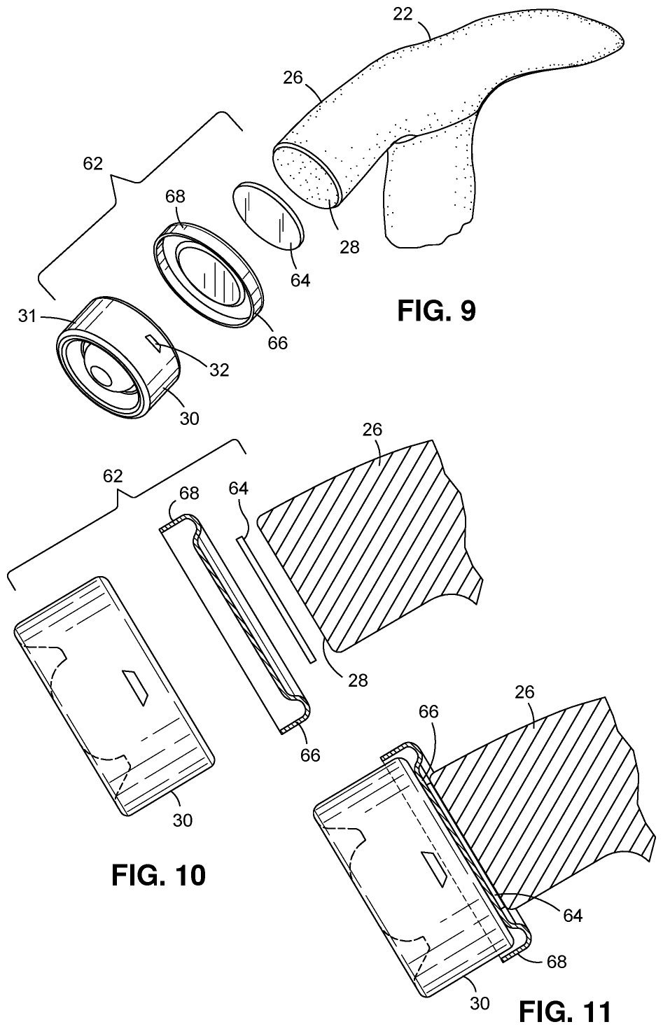

Referring to FIGS. 9, 10 and 11 there is shown an alternate method or apparatus for attaching the LED Light 30 to the face 28 of the cane head 18. Referring particularly to FIGS. 9 and 10 there is shown an exploded view of the attachment device 62 by which the LED light 30 is attached to the face 28 of the cane head 18. A circular shaped two-sided adhesive disc 64 is attached to the face 28 of the cane head 18 and to the rear of steel cup 66. The attachment device 62 additionally includes a strong disc shaped magnet (not shown) that is attached to the rear of the housing 31 of the LED light 30 or contained within the housing 31. The magnet is centered at the back of the LED light 30 housing 31 so that it can be coupled to the steel cup 66 to hold the LED light 30 in place on the cane head 18. The cup 66 includes a raised rim 68. FIG. 11 shows the device 62 in coupled form. The rim 68 may prevent slippage of the LED light 30 from becoming detached from the cane head 18 during normal usage since the light 30 nests within the rim 68 of the cup 66.

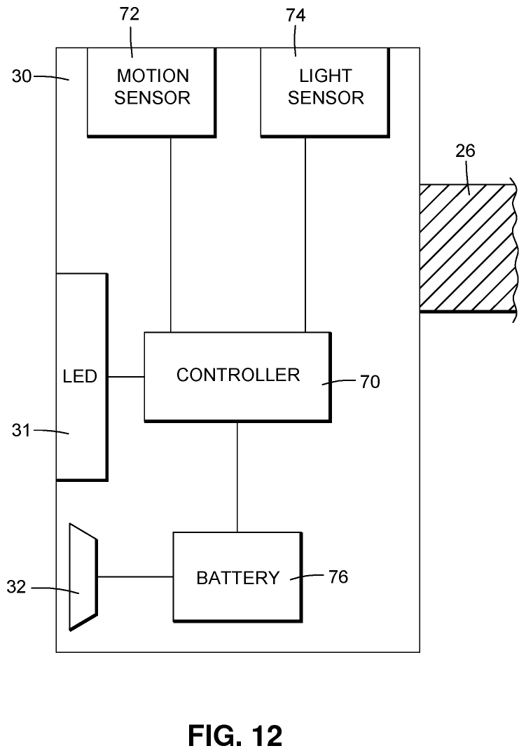

Referring particularly to FIG. 12, there is shown the LED light 30 or illumination source that includes one or more LED lights 31 incorporated in a housing of the illumination source 30. The light 30 is attached to the forward protrusion 26 of the cane head 18. On board the light 30 a controller 70 or microprocessor that receives signals from a motion sensor 72 and a light sensor 74. The motion sensor 72 detects motion within the proximity of the sensor and also may sense the movement of the device 2. When the controller 70 receives a signal from the motion sensor 72 that motion has been detected and also receives a signal from the light sensor 74 that such sensor senses a low light condition or detects the ambient light levels reaching a predetermined threshold the controller 70 sends a signal to the LED 31 to activate and turn on the LED 31. Similarly, when one or both of the motion sensor 72 or light sensor 74 no longer detects motion or the predetermined light level, respectively the controller 70 causes the LED 31 to deactivate. The deactivation may be immediate or based on a predetermined delay. An on-board battery 76 may be charged through a power port 32, and the battery 76 supplies power to the electronic components of the light 72.

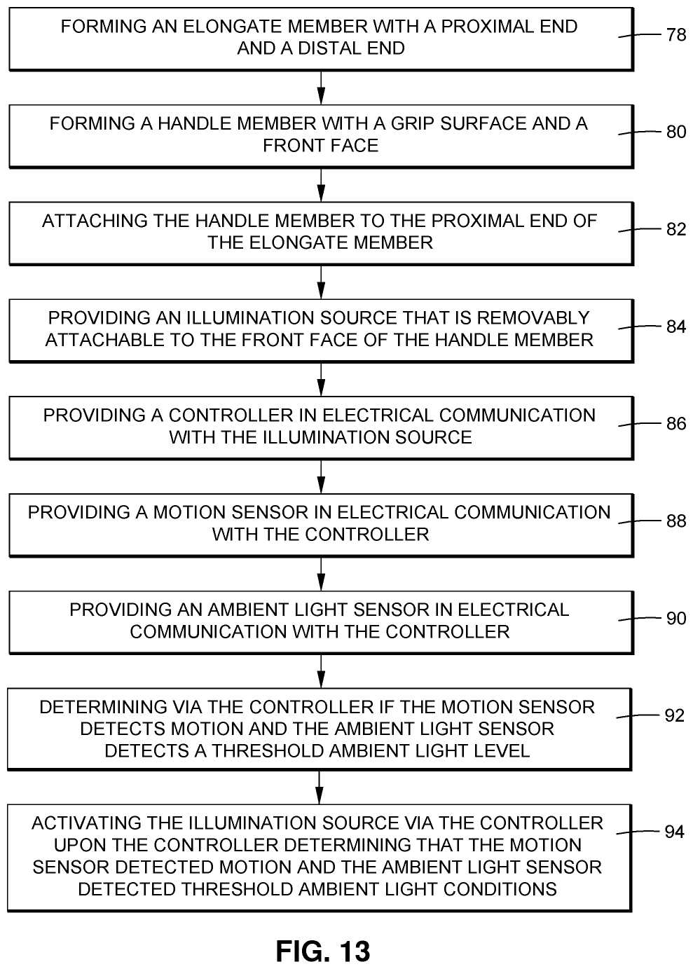

Referring to FIG. 13 there is shown a flow chart showing the following steps of the method for forming a lighted walking cane comprising: forming an elongate member with a proximal end and a distal end (78); forming a handle member with a grip surface and a front face (80); attaching the handle member to the proximal end of the elongate member (82); providing an illumination source that is removably attachable to the front face of the handle member (84); providing a controller in electrical communication with the illumination source (86); providing a motion sensor in electrical communication with the controller (88); providing an ambient light sensor in electrical communication with the controller (90); determining via the controller if the motion sensor detects motion and the ambient light sensor detects a threshold ambient light level (92); activating the illumination source via the controller upon the controller determining that the motion sensor detected motion and the ambient light sensor detected threshold ambient light conditions (94).

The above description is given by way of example, and not limitation. Given the above disclosure, one skilled in the art could devise variations that are within the scope and spirit of the disclosure herein, including structures, assemblies and way of fabricating the disclosed embodiments of the walking cane. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A walking cane, comprising:
an elongate member with a proximal end and a distal end;
a handle member attached to the proximal end, the handle member comprising a grip surface and a front face;
an illumination source removably attachable to the front face of the handle member, said illumination source comprising:
at least one LED light;
a motion sensor;
an ambient light sensor; and
a controller in electrical communication with the motion sensor and ambient light sensor for activating the LED light upon receiving a signal from the motion sensor indicating motion detection and also receiving a signal from the ambient light sensor for detecting a threshold ambient light level.

2. The walking cane of claim 1 wherein the motion sensor is an infrared motion sensor.

3. The walking came of claim 1 wherein the motion sensor is an accelerometer.

4. The walking cane of claim 1 wherein the front face further comprises a steel surface.

5. The walking cane of claim 4 wherein the illumination source further comprises a magnet attachable to the steel surface.

6. The walking cane of claim 1 wherein the illumination source is attached to the front face via an adhesive.

7. The walking cane of claim 1 where the illumination source and the front face of the handle include complementary hook and loop fasteners for removably attaching the illumination source to the front face.

8. The walking cane of claim 1 wherein the illumination source comprises a plurality of light emitting diodes.

9. The walking cane of claim 1 wherein the illumination source further comprises a battery.

10. The walking cane of claim 9 wherein the battery is a rechargeable battery.

11. The walking cane of claim 1 wherein the illumination source further comprises a power port.

12. The walking cane of claim 11 wherein the power port is a USB-C port.

13. The walking cane of claim 1 wherein the distal end of the elongate member further comprises a four-prong foot base.

14. The walking cane of claim 4 wherein the steel surface includes a forward extending raised end.

15. A method of forming a lighted walking cane, comprising:
forming an elongate member with a proximal end and a distal end;
forming a handle member with a grip surface and a front face;
attaching the handle member to the proximal end of the elongate member;
providing an illumination source that is removably attachable to the front face of the handle member;
providing a controller in electrical communication with the illumination source;
providing a motion sensor in electrical communication with the controller;
providing an ambient light sensor in electrical communication with the controller;
determining via the controller if the motion sensor detects motion and the ambient light sensor detects a threshold ambient light level; and
activating the illumination source via the controller upon the controller determining that the motion sensor detected motion and the ambient light sensor detected threshold ambient light conditions.

16. The method of claim 14 further comprising the step of attaching a steel surface to the front face of the handle member.

17. The method of claim 14 further comprising the step of attaching a magnet to the illumination source.

18. The method of claim 16 further comprising the step of attaching the illuminator via the magnet to a steel surface attached to the front face of the handle member.

19. The method of claim 14 further comprising attaching the illuminator to the front face of the handle member via an adhesive.

20. The method of claim 14 further comprising attaching a four-prong foot base to the distal end of the elongate member.

21. The method of claim 15 further comprising configuring the steel surface to have raised portions along the perimeter of the steel surface.
